(19) United States
(12) Patent Application Publication
(10) Pub. No.: US 2006/0209173 A1
(43) Pub. Date: Sep. 21, 2006

(54) System and method for creation of videoprograms

(76) Inventor: Alexandr Vasilievich Volkov, Taganrog (RU)

Correspondence Address: Andrey Ermolinsky, P O Box 35-94, Vladivostok, 690035, RU

(21) Appl. No.: 10/568,366

(22) PCT Filed: Aug. 20, 2004
(86) PCT No.: PCT/RU04/00329

§ 371 Date: Feb. 14, 2006

(30) Foreign Application Priority Data
Aug. 25, 2003 (RU) 2003126029

(51) Int. Cl. H04N 7/14

(52) U.S. Cl. 348/14.01

(57) ABSTRACT

The objects of the present invention are to simplify perception of recorded psychophysiological reactions of a person in response to verbal influences and to create a new kind of videoprograms. The inventive system comprises a videocamera (1) to shoot a participant (2), generating means (5) to generate a videoimage, measuring means (4) to measure data of reflex psychophysiological reactions of the participant (2) in response to verbal influences, mixing means (5) to add parameters of the measured data of the reflex psychophysiological reactions, a microphone (3) to record a sound of the participant's voice, combining means (5) to combine the recorded sound with the participant's image and/or to transform the recorded sound into an appropriate text. The mixing means (5) includes a modifying unit to modify the videoimage and/or its soundtrack in response to a change of the parameters of the measured data after a testing question.

### TECHNICAL FIELD

The invention relates to data processing equipment and methods specially adapted for specific functions, and more particularly to systems and methods for analysis of psychophysiological reactions of the person in response to verbal influences. It is possible to use the invention for medicine, litigation, entertainment, or mass media.

### BACKGROUND ART

Various devices for analysis of psychophysiological information by reflex reactions of the person in response to verbal influences are known. The principle of functioning of known devices is based on essential difference of character of changes of measured dynamic characteristics of an examinee during the examinee reply on relevant and irrelevant questions. The known devices carry out data registration, processing and convenient displaying of change of dynamic characteristics of pulse, respiration, skin galvanic resistance (conduction), a blood pressure, and also other similar characteristics which may be measured and reflects a reflex reaction of parameters of an organism in response to testing question. For example, there are known such devices as strain-measuring platforms, voice stresses-detectors, polygraphs [for example, see description of a patent on invention RU 2125399, 1999]. The analysis of the psychophysiological information with use of these known devices may be carried out by the qualified professional only.

It is known a device for analysis of psychophysiological information [patent on invention RU 2125399, 1999]. The device comprises a sensors unit, a functional converters unit, a reproduction unit, a display unit, an animated picture signal former. The analysis of a form and dynamics of the animated picture generated by means of this known device may be carried out by the qualified professional only.

Both an increase of reliability of data processing and an improvement of a data format used in modern devices for the analysis of psychophysiological information allows to apply these devices in other spheres. For example, videoshooting, measuring of psychophysiological information and imagery by a computer are combined together in the known method and device for production of videoprograms [patent on invention RU 2157054, 2000]. This system comprises a videocamera placed in studios and intended for shooting a participant of the videoprogram, means for generating videoimage which includes both objects of a foreground and objects of a background image. The system also includes means for mixing images, the first input of this means is connected to an output of the videocamera, and the second input of the means is connected to an output of the means for videoimage generating. Said means for mixing images is executed with an opportunity to mix the image of objects of the foreground with the image of the participant. For creation of videoprograms in a mode of videoconferences it is possible to register psychophysiological data of the participant during his (her) interaction with displayed objects of the image formed by the computer and to mix indexes of the registered data with other images of the videoprogram. Thus it is possible to carry out monitoring of a psychophysiological condition of the participant by a sensor unit measuring an emotional condition (for example by means of “a lie detector” or a polygraph). However, these known method and device have a narrow field of use.

### DISCLOSURE OF THE INVENTION

It is a primary object of the present invention to simplify perception and the analysis of recorded psychophysiological reactions of a person in response to verbal influences. Another object of the present invention is creating a new kind of videoprograms.

An inventive system for creation of videoprograms comprises a videocamera to shoot a participant of the videoprogram, generating means to generate a videoimage of the videoprogram including an image of the participant shot by the videocamera, measuring means to measure data of reflex psychophysiological reactions of the participant in response to verbal influences during the shooting of the participant, mixing means to add parameters of the measured data of the reflex psychophysiological reactions to the videoimage of the videoprogram. That is new that in addition the system comprises a microphone to record a sound of a voice of the participant during the shooting of the participant, combining means to combine the recorded sound of the voice of the participant with the image of the participant and/or to transform the sound of the voice into an appropriate text and to add the appropriate text as its image to the videoimage of the videoprogram (for example, as a “running line”). Also, the mixing means includes a modifying unit to modify the videoimage of the videoprogram and/or its soundtrack in response to a change of the parameters of the measured data after the verbal influence such as a testing question.

There may be different embodiments of the modifying unit as follows:

said modifying unit is capable to modify the image of the participant and/or the image of the appropriate text and/or other objects of the videoimage of the videoprogram in manner to change their form and/or color and/or luminance and/or contrast and/or frequency of occurrence;

said modifying unit is capable to form a separate animated image which reflects a level of the change of the parameters of the measured data; or

said modifying unit is capable to change amplitude-frequency characteristics of the recorded sound of the voice of the participant.

The purpose of the above-mentioned modifying units is displaying on a screen (for example, in real time) of honesty or dishonesty of the participant's reply on the specific testing question presented to the participant, and said honesty or dishonesty is determined with the certain degree of reliability which may be achieved by the using measuring means.

It may be used different measuring means as follows:

a voice stresses-detector reacting to the sound of the voice of the participant recorded by the microphone;

a strain-measuring platform; or

as a polygraph.

The purpose of the above-mentioned measuring means is determining honesty or dishonesty of the participant's reply on the presented testing question. This determining will be in borders of the achievable degree of reliability.

Further, the measuring means can include a sensor unit to measure physiological parameters of an organism of the participant which give in to measuring and reflect the reflex psychophysiological reaction of the participant after the testing question. This sensor unit may comprise a gauge or gauges chosen of a following group: a gauge of a pulse wave, a gauge of a pulse rate, a gauge of frequency of respiration, a gauge of bioelectric signals of a brain, a gauge of electric conduction of a skin, and so on.

An inventive method for creation of videoprograms comprises the steps of: videoshooting a participant of the videoprogram; measuring data of reflex psychophysiological reactions of the participant in response to verbal influences during the videoshooting of the participant; generating a videoimage of the videoprogram including a shot image of the participant; adding parameters of the measured data of the reflex psychophysiological reactions to the videoimage of the videoprogram. That is new that there are the additional steps of: recording a sound of a voice of the participant during the videoshooting of the participant; combining the recorded sound of the voice of the participant with the image of the participant and/or transforming the sound of the voice into an appropriate text and further adding the appropriate text as its image to the videoimage of the videoprogram; and modifying the videoimage of the videoprogram and/or its soundtrack in response to a change of the parameters of the measured data after the verbal influence such as a testing question.

The modifying the videoimage may be carried out as follows:

modifying the image of the participant and/or an image of the appropriate text and/or other objects of the videoimage of the videopgogram by means of changing their form and/or color and/or luminance and/or contrast and/or frequency of occurrence;

forming a separate animated image which reflects a level of the change of the parameters of the measured data.

Also the modifying may be carried out by means of changing amplitude-frequency characteristics of the recorded sound of the voice of the participant.

It is better when the measuring is carried out as measuring physiological parameters of an organism of the participant which give in to measuring and reflect the reflex psychophysiological reaction of the participant after the testing question.

### BRIEF DESCRIPTION OF THE FIGURES ON THE DRAWINGS

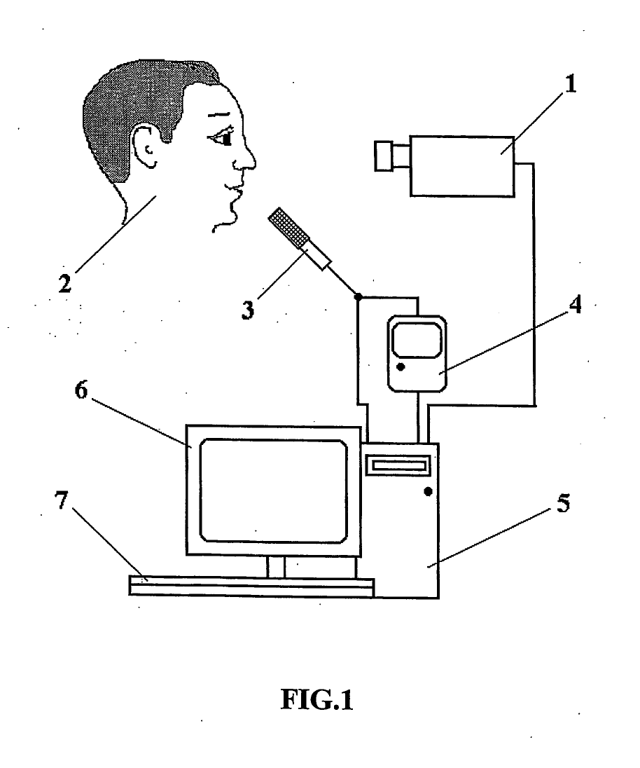

The invention is described with reference to the accompanying drawing which show one of embodiments. There is the only FIG. 1 which shows a basic scheme of a system of creation of digital videoprograms.

### THE EXAMPLE FOR CARRYING OUT THE INVENTION

The invention is explained on an example of system of creation of digital videoprograms.

This system includes a digital videocamera 1 for shooting a participant 2 of the videoprogram, a microphone 3 having a built-in converter for transformation an electric signal into a digital format. An output of the microphone 3 is in parallel connected to both a port of a voice stress-detector 4 and USB-port of a personal computer 5. An output of the videocamera 1 is connected to other USB-port of the computer 5. The computer 5 is equipped with devices and software to have possibility of processing of digital maps; it also has input\output devices such as a screen monitor 6, a keyboard 7, a device for reading and recording on the optical disk such as a CD-writer 7 and others.

For creation of the videoprogram, the participant 2 is videoshot by the videocamera 1. A series of testing questions (which also may be in the videoimage and/or a soundtrack) is presented to the participant 2 during the videoshooting. Replies of the participant 2 on this questions are recorded by the microphone 3. A sound of a participant's voice is transformed into a digital signal, this signal moves both directly and through the stress-detector 4 for further processing by the computer 5, thus the stress-detector 4 forms signals which correspond to honesty or dishonesty of the participant 2 in replies on the testing questions. The computer 5 forms the videoprogram by means of its hardware-software means; the generated videoprogram includes in particular: an image of the participant 2, an image of a background and a soundtrack as the sound of the voice of the participant 2 and a sound of testing questions (for example, asked by a leader of the videoprogram). It is possible to support of the sound with “the running line” of the text corresponding to both testing questions and replies of the participant 2, thus the formation of the text is made by processing by the appropriate hardware-software means of recognition of speech by the digital signals from the microphone 3. Both pixels of the videoimage and the soundtrack do not change in case the stress-detector 4 forms a digital signal which corresponds to honesty of a reply on a testing question, or as addition to this, the hardware-software mixing means of the computer 5 forms an animated image corresponding to honesty and adds such animated image with the videoimage of the videoprogram. If the stress-detector 4 forms a digital signal which corresponds to dishonesty of a reply on a testing question; in this case the hardware-software mixing means of the computer 5 modify the objects of the videoimage and/or its soundtrack in manner to change: form and/or color and/or luminance and/or contrast and/or frequency of occurrence of the participant 2 (for example, as an effect of “blinking”) and/or the background and/or “the running line”; or as addition to this, the hardware-software mixing means of the computer 5 forms an animated image corresponding to dishonesty and adds this animated image to the videoimage of the videoprogram. It is possible to insert both items of necessary changing objects and the manner of changing before the videoshooting. It may be done by means of the keyboard 7 (or a mouse), for example by checking appropriate fields of an appropriate user interface displayed on the screen monitor 6. The created videoprogram is written to a hard disk of the computer 5 or on the optical disk by the CD-writer 7, or it is sent by means of the telecommunication network etc.

It may be other measuring means instead of the voice stress-detector accordingly the above-mentioned example. Other measuring means may be independent from the microphone 3. For instance, it may be a strain-measuring platforms [for example, as in the patent RU 2112423, 1998] or a polygraph having a sensors unit of bioelectrical signals of the brain [for example, as in the patent U.S. Pat. No. 4,932,416, 1990]. These means may be connected to ports of the computer 5 by means of different kinds of known ports.

It is necessary to note, that all hardware-software means (or the most part from them) given in the example and claims may be incorporated in one design of a videocamera 1.

The presented example is used only for the purposes to illustrate one embodiment of the present invention and is not to be taken by way of limitation. The scope of the present invention are to be limited only by the claims. Thus an expert in this technical field is able to carry out other embodiments of the present invention in rather simple manner. Also; the software required for embodiment of the present invention may be created by a software expert in rather simple manner on the basis of the claims.

1. A system for creation of videoprograms comprising a videocamera to shoot a participant of the videoprogram, generating means to generate a videoimage of the videoprogram including an image of the participant shot by the videocamera, measuring means to measure data of reflex psychophysiological reactions of the participant in response to verbal influences during the shooting of the participant, mixing means to add parameters of the measured data of the reflex psychophysiological reactions to the videoimage of the videoprogram, wherein in addition the system comprises a microphone to record a sound of a voice of the participant during the shooting of the participant, combining means to combine the recorded sound of the voice of the participant with the image of the participant, and the mixing means includes a modifying unit to change amplitude-frequency characteristics of the recorded sound of the voice of the participant in response to a change of the parameters of the measured data which corresponds to dishonesty of the participant after the verbal influence such as a testing question.

2. The system of claim 1, wherein the mixing means includes an additional modifying unit to modify videoimage of the videoprogram in response to the change of the parameters of the measured data.

3. The system of claim 2, wherein the additional modifying unit is capable to modify the image of the participant and/or another object of the videoimage of the videoprogram in manner to change its form and/or color and/or luminance and/or contrast and/or frequency of occurrence.

4. The system of claim 2, wherein the additional modifying unit is capable to form a separate animated image which reflects a level of the change of the parameters of the measured data.

5. The system of claim 2, wherein it is a transforming means to transform the sound of the voice of the participant into an appropriate text and to add the appropriate text as its image to the videoimage of the videoprogram.

6. The system of claim 5, wherein the additional modifying unit is capable to modify the image of the appropriate text in manner to change its form and/or color and/or luminance and/or contrast and/or frequency of occurrence.

7. The system of claim 1, wherein the measuring means is carried out as a voice stresses-detector reacting to the sound of the voice of the participant recorded by the microphone.

8. The system of claim 1, wherein the measuring means is carried out as a strain-measuring platform.

9. The system of claim 1, wherein the measuring means is carried out as a polygraph.

10. The system of claim 1, wherein the measuring means includes a sensor unit to measure physiological parameters of an organism of the participant which give in to measuring and reflect the reflex psychophysiological reaction of the participant after the testing question.

11. The system of claim 10, wherein the sensor unit comprises a gauge or gauges chosen of a following group: a gauge of a pulse wave, a gauge of a pulse rate, a gauge of frequency of respiration, a gauge of bioelectric signals of a brain, and a gauge of electric conduction of a skin.

12. A method for creation of videoprograms comprising the steps of: videoshooting a participant of the videoprogram; measuring data of reflex psychophysiological reactions of the participant in response to verbal influences during the videoshooting of the participant; generating a videoimage of the videoprogram including a shot image of the participant; adding parameters of the measured data of the reflex psychophysiological reactions to the videoimage of the videoprogram, wherein in addition there are the steps of: recording a sound of a voice of the participant during the videoshooting of the participant; combining the recorded sound of the voice of the participant with the image of the participant; and modifying a soundtrack of the videoprogram which is carried out by means of changing amplitude-frequency characteristics of the recorded sound of the voice of the participant in response to a change of the parameters of the measured data which corresponds to dishonesty of the participant after the verbal influence such as a testing question.

13. The method of claim 10, wherein it is an additional step of modifying the videoimage of the videoprogram in response to the change of the parameters of the measured data.

14. The method of claim 13, wherein the modifying the videoimage is carried out as modifying the image of the participant and/or another object of the videoimage of the videoprogram by means of changing their form and/or color and/or luminance and/or contrast and/or frequency of occurrence.

15. The method of claim 13, wherein it is another additional step of transforming the sound of the voice into an appropriate text and further adding the appropriate text as its image to the videoimage of the videoprogram.

16. The method of claim 15, wherein the modifying the videoimage is carried out as modifying the image of the appropriate text by means of changing their form and/or color and/or luminance and/or contrast and/or frequency of occurrence.

17. The method of claim 13, wherein the modifying the videoimage is carried out as forming a separate animated image which reflects a level of the change of the parameters of the measured data.

18. The method of claim 12, wherein the measuring is carried out as measuring physiological parameters of an organism of the participant which give in to measuring and reflect the reflex psychophysiological reaction of the participant after the testing question.

19. A system for creation of videoprograms comprising a videocamera to shoot a participant of the videoprogram, generating means to generate a videoimage of the videoprogram including an image of the participant shot by the videocamera, measuring means to measure data of reflex psychophysiological reactions of the participant in response to verbal influences during the shooting of the participant, mixing means to add parameters of the measured data of the reflex psychophysiological reactions to the videoimage of the videoprogram, wherein in addition the system comprises a microphone to record a sound of a voice of the participant during the shooting of the participant, combining means to combine the recorded sound of the voice of the participant with the image of the participant and/or to transform the sound of the voice into an appropriate text and to add the appropriate text as its image to the videoimage of the videoprogram, and the mixing means includes a modifying unit to modify the videoimage of the videoprogram and/or its soundtrack in response to a change of the parameters of the measured data after the verbal influence such as a testing question, and said means are incorporated in one design of the videocamera.

20. The system of claim 19, wherein the modifying unit is capable to modify the image of the participant and/or the image of the appropriate text and/or other objects of the videoimage of the videoprogram in manner to change their form and/or color and/or luminance and/or contrast and/or frequency of occurrence.

21. The system of claim 19, wherein the modifying unit is capable to form a separate animated image which reflects a level of the change of the parameters of the measured data.

22. The system of claim 19, wherein the modifying unit is capable to change amplitude-frequency characteristics of the recorded sound of the voice of the participant.

23. The system of claim 19, wherein the measuring means is carried out as a voice stresses-detector reacting to the sound of the voice of the participant recorded by the microphone.

24. The system of claim 19, wherein the measuring means is carried out as a polygraph.

25. The system of claim 19, wherein the measuring means includes a sensor unit to measure physiological parameters of an organism of the participant which give in to measuring and reflect the reflex psychophysiological reaction of the participant after the testing question.

26. The system of claim 25, wherein the sensor unit comprises a gauge or gauges chosen of a following group: a gauge of a pulse wave, a gauge of a pulse rate, a gauge of frequency of respiration, a gauge of bioelectric signals of a brain, and a gauge of electric conduction of a skin.
